(19) United States
(12) Patent Application Publication
(10) Pub. No.: US 2020/0068441 A1
(43) Pub. Date: Feb. 27, 2020

(54) Enabling Communication of a Wireless Device in a Wireless Communication Network

(71) Applicant: Telefonaktiebolaget LM Ericsson (publ), Stockholm (SE)

(72) Inventors: Marco Belleschi, Solna (SE); Ricardo Blasco Serrano, Espoo (FI)

(21) Appl. No.: 16/609,623

(22) PCT Filed: May 9, 2018
(86) PCT No.: PCT/SE2018/050487

§ 371 Date: Oct. 30, 2019

Related U.S. Application Data
(60) Provisional application No. 62/505,164, filed on May 12, 2017.

(51) Int. Cl. H04W 28/18

(52) U.S. Cl. CPC H04W 28/18; H04W 88/02

(57) ABSTRACT

Embodiments herein relate e.g. to a method performed by a wireless device (10) for handling communication in a wireless communication network. The wireless device (10) determines sets of values of transmission parameters based on two or more conditions, wherein the transmission parameters are related to wireless devices. The wireless device (10) determines whether there is one or more overlapping values of the sets of values. When determined that there is one or more overlapping values, the wireless device (10) selects a value of the one or more overlapping values; and when determined that there is no overlapping values, the wireless device (10) selects a value from the sets of values of transmission parameters based on a criteria.

### TECHNICAL FIELD

Embodiments herein relate to a radio network node, a wireless device and methods performed therein. Furthermore, a computer program product and a computer readable storage medium are also provided herein. In particular, embodiments herein relate to enable communication of the wireless device in a wireless communication network.

### BACKGROUND

In a typical wireless communication network, wireless devices, also known as wireless communication devices, mobile stations, stations (STA) and/or user equipments (UE), communicate via a Radio Access Network (RAN) to one or more core networks (CN). The RAN covers a geographical area and provides radio coverage over service areas or cells, which may also be referred to as a beam or a beam group, with each service area or beam being served or controlled by a radio network node such as a radio access node e.g., a Wi-Fi access point or a radio base station (RBS), which in some networks may also be denoted, for example, a NodeB, an eNodeB, or a gNodeB. The radio network node communicates over an air interface operating on radio frequencies with the wireless device within range of the radio network node.

A Universal Mobile Telecommunications network (UMTS) is a third generation (3G) telecommunications network, which is evolved from the second generation (2G) Global System for Mobile Communications (GSM). The UMTS terrestrial radio access network (UTRAN) is essentially a RAN using wideband code division multiple access (WCDMA) and/or High Speed Packet Access (HSPA) for user equipments. In a forum known as the Third Generation Partnership Project (3GPP), telecommunications suppliers propose and agree upon standards for third generation networks, and investigate enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. This type of connection is sometimes referred to as a backhaul connection. The RNCs and BSCs are typically connected to one or more core networks.

Specifications for the Evolved Packet System (EPS), also called a Fourth Generation (4G) network, have been completed within the 3^{rd} Generation Partnership Project (3GPP) and this work continues in the coming 3GPP releases, for example to specify a Fifth Generation (5G) network. The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs. In general, in E-UTRAN/LTE the functions of an RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted as the X2 interface.

For the 5G system currently being standardized by 3GPP, where the radio access network is referred to as New Radio (NR) and the core network is referred to as Next Generation Core (NGC), 3GPP has agreed to partly change the principles for distribution of system information (SI) that are used in LTE.

During Release 12, the LTE standard has been extended with support of device to device (D2D) (specified as “sidelink”) features targeting both commercial and Public Safety applications. Some applications enabled by Rel-12 LTE are device discovery, where wireless devices are able to sense the proximity of another wireless device and associated application by broadcasting and detecting discovery messages that carry wireless device and application identities. Another application consists of direct communication based on physical channels terminated directly between wireless devices. In 3GPP, all of these applications are defined under the umbrella of Proximity Services (ProSe).

One of the potential extensions of the ProSe framework consists of support of Vehicle to everything (V2x) communication, which includes any combination of direct communication between vehicles, pedestrians, and infrastructure. V2x communication may take advantage of a Network (NW) infrastructure, when available, but at least basic V2x connectivity should be possible even in case of lack of coverage. Providing an LTE-based V2x interface may be economically advantageous because of the LTE economies of scale and it may enable tighter integration between communications with the NW infrastructure e.g. Vehicle to Infrastructure (V2I) and Vehicle to Pedestrians (V2P) and Vehicle to Vehicle (V2V) communications, as compared to using a dedicated V2x technology.

There are many research projects and field tests of connected vehicles in various countries or regions, including projects that are based on the use of existing cellular infrastructure.

V2x communications may carry both non-safety and safety information, where each of the applications and services may be associated with specific requirements sets, e.g., in terms of latency, reliability, capacity, etc. From the application point of view, V2X includes the following types of communication/services. FIG. 1 shows Error! Reference source not found.

V2V (Vehicle to Vehicle):

Covers communication between vehicles using V2V applications and is predominantly broadcast-based. V2V may be realized by either direct communication between the devices in the respective vehicles, or via infrastructure such as a cellular network. An example of V2V is the transmission of a cooperative awareness message (CAM) with vehicle status information (such as position, direction, and speed) transmitted to other vehicles in the proximity repeatedly (every 100 ms-1 s). Another example is the transmission of a decentralized environmental notification message (DENM), which is an event-triggered message to alert vehicles. These two examples are taken from the ETSI Intelligent Transport Systems (ITS) specification of V2X applications, which also specifies the conditions under which the messages are generated. Main characteristic of V2V applications is the tight requirements on latency that can vary from ms (for pre-crash warning messages) to 100 ms for other road safety services.

V2I (Vehicle to Infrastructure):

This comprises communication between vehicles and a Roadside Unit (RSU). The RSU is a stationary transportation infrastructure entity which communicates with vehicles in its proximity. An example of V2I is transmission of speed notifications from the RSU to vehicles, as well as queue information, collision risk alerts, curve speed warnings. Due to the safety related nature of V2I, delay requirements are similar to V2V requirements.

V2P (Vehicle to Pedestrian):

Covers communication between vehicles and vulnerable road users, such as pedestrians, using V2P applications. V2P typically takes place between distinct vehicles and pedestrians either directly or via infrastructure such as cellular network.

V2N (Vehicle to Network):

Covers communication between a vehicle and a centralized application server (or an Intelligent transportation systems (ITS) Traffic Management Center) both using V2N applications, via infrastructure (such as a cellular network). One example is a bad road condition warning sent to all vehicles in a wide area, or traffic flow optimization in which V2N application suggests speeds to vehicles and coordinates traffic lights. Therefore, V2N messages are supposed to be controlled by a centralized entity (i.e. the Traffic Management Center) and provisioned to vehicles in a large geographical area, rather than in a small area. Additionally, unlike V2V/V2I, latency requirements are more relaxed in V2N because it is not meant to be used for non-safety purposes, e.g. 1 s latency requirement is typically considered.

As previously mentioned Sidelink transmissions (also known as D2D or ProSe) over the so-called PC5 interface in cellular spectrum have been standardized in 3GPP since Rel-12. In 3GPP Rel-12 two different transmission modes have been specified in 3GPP. In one mode (mode-1), a UE in RRC_CONNECTED mode requests D2D resources and the eNB grants them via PDCCH (DCI5) or via dedicated signalling. In another mode (mode-2), a UE autonomously selects resources for transmission from a pool of available resources that the eNB provides in broadcast via SIB signalling for transmissions on carriers other than the PCell or via dedicated signaling for transmission on the PCell. Therefore, unlike the first operation mode, the second operation mode can be performed also by UEs in RRC_IDLE and in some cases even by UEs out of coverage.

In Rel.14, the usage of sidelink is extended to the V2x domain. The original design of the sidelink physical layer in Rel.12 targeted a scenario with a small number of wireless devices such as UEs competing for the same physical resources in the spectrum, to carry voice packet for Mission Critical Push To Talk (MCPTT) traffic, and assumed low wireless device mobility. On the other hand, in V2x the sidelink should be able to cope with higher load scenario (i.e., hundreds of cars potentially contending for physical resources), to carry time/event triggered V2x messages e.g. Cooperative Awareness Message (CAM) and Decentralized Environmental Notification Message (DENM), and with high wireless device mobility. For such reasons, 3GPP has discussed possible enhancements to the sidelink physical layer.

A first enhancement that has been specified in Rel.14 is the introduction of a new transmission mode, i.e. mode-3, which resembles mode-1 in the sense that it is the radio network node such as an eNB that explicitly assigns sidelink resources to the wireless device. However, unlike mode-1, the radio network node has the possibility to configure the sidelink resources semi-persistently in a Semi Persistent Scheduling (SPS)-like fashion, i.e. the eNB assigns a sidelink grant for periodic transmissions on a certain frequency resource.

A second enhancement is the introduction of the so-called channel sensing and sensing-aware wireless device autonomous resource allocation, which corresponds to mode-4 transmission mode. Unlike random resource selection which is the base for Rel.12 and Rel.13 ProSe communications, in V2V (Rel-14) wireless devices are expected to continuously sense the channel and search for resources in the different part of the spectrum that are less interfered. Such sensing has the objective to limit collisions between wireless devices.

Two types of sensing have been considered in 3GPP:
Sensing based on received power. A wireless device measures the received energy on specific radio resources:
   For example, based on these measurements, the wireless device decides whether the radio resources are considered to be in use by some other wireless device (i.e., ‘busy’) or not (i.e., ‘idle’).
   For example, the wireless device may use the measurements to estimate whether the transmitter is far away (e.g., if the signal is weak) or nearby (e.g., if the signal is strong).
Sensing based on packet contents. A wireless device receives a packet and decodes it. Based on the information extracted from the packet, the wireless device may obtain some knowledge about the utilization of radio resources:
   For example, by reading a scheduling assignment (SA) packet a wireless device may know in which radio resources to expect data transmissions, and the priority level of the transmitter.
   For example, by reading a data packet a wireless device may know the position of the transmitter, the ID of transmitter, the type of transmitter, etc.

Although in mode-4 the wireless device autonomously selects the transmission resources on the basis of the sensing results, it is still possible for the radio network node to signal some sets of the values that are allowed the wireless device to use for certain transmission parameters. For example, for the number of Physical Resource Blocks (PRB) used by a wireless device for a transmission the radio network node may specify a minimum and maximum value, i.e., the wireless device is not allowed to use less than X PRBs or more than Y PRBs for the transmission; whether the wireless device is allowed to transmit or not; the maximum and minimum Modulation and Coding Scheme (MCS) the wireless device may use, the minimum/maximum transmission power; etc. In other words, the radio network node can restrict the set of values that the wireless device can select for certain transmission parameters. Such sets/restrictions (on the transmission parameters) may be configured differently by the network for different wireless device conditions e.g. depending on the wireless device speed or channel congestion status. In addition to configuration by the radio network node (or a NW node in general), the sets/restrictions may also be part of a pre-configuration. Pre-configuration may be used as an alternative or as a complement to configuration by the radio network node.

With the existing specification, the radio network node can configure different sets of values for the transmission parameters for different wireless device conditions, e.g. wireless device speed, channel congestion status. For example, the radio network node may configure a first set of transmission parameters ranges, e.g. number of PRBs, MCS, transmission power, number of Hybrid Automatic Repeat Request (HARQ) retransmissions etc. that are dependent on the wireless device speed. Additionally, the radio network node may also configure a second set of transmission parameters ranges that the wireless device should follow depending on the congestion status of the sidelink channel.

In the following a possible configuration is provided by the radio network node
Speed-dependent Transmission (TX) parameters and their ranges, i.e., sets of allowed values:
   Speed 0 kmph-60 kmph: Speed-ParametersA
      PRB-RangeA, MCS-RangeA, HARQ-RangeA, TX-PowerA
   Speed 60 kmph-100 kmph: Speed-ParametersB
      PRB-RangeB, MCS-RangeB, HARQ-RangeB, TX-PowerB
   Speed >100 kmph: Speed-ParametersC
      PRB-RangeC, MCS-RangeC, HARQ-RangeC, TX-PowerC
Congestion-dependent TX parameters and their ranges (i.e., sets of allowed values):
   CBR 0%-20%: Cong-ParametersA
      PRB-RangeA, MCS-RangeA, HARQ-RangeA, TX-PowerA
   CBR 20%-70%: Cong-ParametersB
      PRB-RangeB, MCS-RangeB, HARQ-RangeB, TX-PowerB
   CBR >70%: Cong-ParametersC
      PRB-RangeC, MCS-RangeC, HARQ-RangeC, TX-PowerC

Channel Busy Ratio (CBR) is a metric that measures the level of congestions.

Note that in general the radio network node could provide only one of the configurations, both them, or none of the configurations.

The wireless device selects the desired value for a transmission parameter within the set of values corresponding to its speed or on the measured channel congestion status. However, it might be ambiguous which values of transmission parameters the wireless device can select from in case multiple sets of transmission parameters are configured, i.e. in case both sets of speed-dependent and congestion-dependent parameters are configured.

One straightforward solution is that the radio network node should always ensure overlapping (intersection) between different configuration parameters and across different sets so that the wireless device can simply select the transmission parameters that overlap. That is, when defining PRB-RangeA in Speed-ParametersA and PRB-RangeA in Cong-ParametersA the radio network node should ensure that there are always some common values to both ranges (i.e., non-empty intersection). In this way, the wireless device can always select a value that meets both restrictions, i.e., that belongs simultaneously to both ranges.

However, this solution has some fundamental limitations, since it constrains the radio network node to always ensure an overlap between different configurations, which might not be always beneficial in terms of system performance. For example, if the wireless device is moving at a speed above 100 km/h, the MCS range should be rather conservative and the allowed number of HARQ retransmission should be high to ensure reliable reception, but if at the same time the congestion of the channel, e.g. CBR, is above 70% it is better to have a more aggressive MCS to limit packet segmentation and low (or no) HARQ retransmissions to reduce the channel overload.

### SUMMARY

An object herein is to provide a mechanism that improves performance of a wireless communication network in an efficient manner.

According to an aspect the object is achieved by providing a method performed by a wireless device for handling communication in a wireless communication network. The wireless device determines sets of values of transmission parameters based on two or more conditions, wherein the transmission parameters are related to wireless devices such as number of PRBs to use, MCS to use or transmission power to use. The wireless device determines whether there is one or more overlapping values of the sets of values. When determined that there is one or more overlapping values, the wireless device selects a value of the one or more overlapping values; and when determined that there is no overlapping values, the wireless device selects a value from the sets of values of transmission parameters based on a criteria.

According to another aspect the object is achieved by providing a method performed by a radio network node for handling radio resources in a wireless communication network. The radio network node configures a wireless device with multiple sets of values of transmission parameters, wherein the transmission parameters are related to conditions being network related conditions and/or wireless device related conditions.

According to yet another aspect the object is achieved by providing a wireless device for handling communication in a wireless communication network. The wireless device is configured to determine sets of values of transmission parameters based on two or more conditions, wherein the transmission parameters are related to wireless devices. The wireless device is further configured to determine whether there is one or more overlapping values of the sets of values. When determined that there is one or more overlapping values, the wireless device is configured to select a value of the one or more overlapping values; and when determined that there is no overlapping values, the wireless device is configured to select a value from the sets of values of transmission parameters based on a criteria.

According to yet another aspect the object is achieved by providing a radio network node for handling radio resources in a wireless communication network. The radio network node is configured to configure a wireless device with multiple sets of values of transmission parameters, wherein the transmission parameters are related network related conditions and/or wireless device related conditions and are for the wireless device to select from.

It is furthermore provided herein a computer program product comprising instructions, which, when executed on at least one processor, cause the at least one processor to carry out any of the methods above, as performed by the wireless device or the radio network node. It is additionally provided herein a computer-readable storage medium, having stored thereon a computer program product comprising instructions which, when executed on at least one processor, cause the at least one processor to carry out the method according to any of the methods above, as performed by the wireless device or the radio network node.

It is herein further disclosed a wireless device comprising processing circuitry configured to determine sets of values of transmission parameters based on two or more conditions, wherein the transmission parameters are related to wireless devices. The processing circuitry is further configured to determine whether there is one or more overlapping values of the sets of values; and when determined that there is one or more overlapping values configured to, select a value of the one or more overlapping values. The processing circuitry is further configure to, when determined that there is no overlapping values, select a value from the sets of values of transmission parameters based on a criteria.

It is herein further disclosed a radio network node comprising processing circuitry configured to configure a wireless device with multiple sets of values of transmission parameters, wherein the transmission parameters are related to network related conditions and/or wireless device related conditions and are for the wireless device to select from.

Embodiments herein enable the wireless device to select a value of transmission parameter values among multiple sets of transmission parameter values which may be configured by the radio network node (or preconfigured) depending on the different conditions. This leads to an improved performance of the wireless communication network in an efficient manner.

### BRIEF DESCRIPTION OF THE DRAWINGS

Embodiments will now be described in more detail in relation to the enclosed drawings, in which:

FIG. 1 is a schematic logical overview depicting vehicle communications;

FIG. 2A is a schematic diagram depicting a wireless communication network according to embodiments herein;

FIG. 2B is a schematic flowchart depicting a method performed by a wireless device according to embodiments herein;

FIG. 2C is a schematic flowchart depicting a method performed by a radio network node according to embodiments herein;

FIG. 3 is a flowchart according to some embodiments herein;

FIG. 4 is a combined flowchart and signalling scheme according to some embodiments herein;

FIG. 5 is a schematic block diagram depicting a wireless device according to embodiments herein;

FIG. 6 is a schematic block diagram depicting a radio network node according to embodiments herein;

FIG. 7 schematically illustrates a telecommunication network connected via an intermediate network to a host computer;

FIG. 8 is a generalized block diagram of a host computer communicating via a base station with a user equipment over a partially wireless connection; and

FIGS. 9-12 are flowcharts illustrating methods implemented in a communication system including a host computer, a base station and a user equipment.

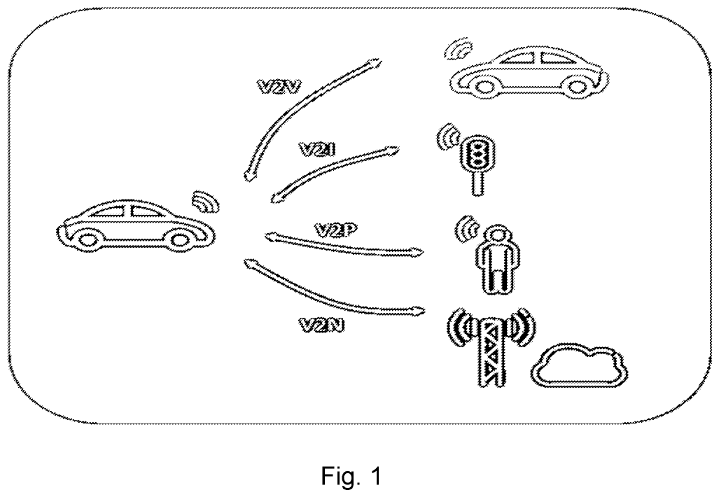

### DETAILED DESCRIPTION

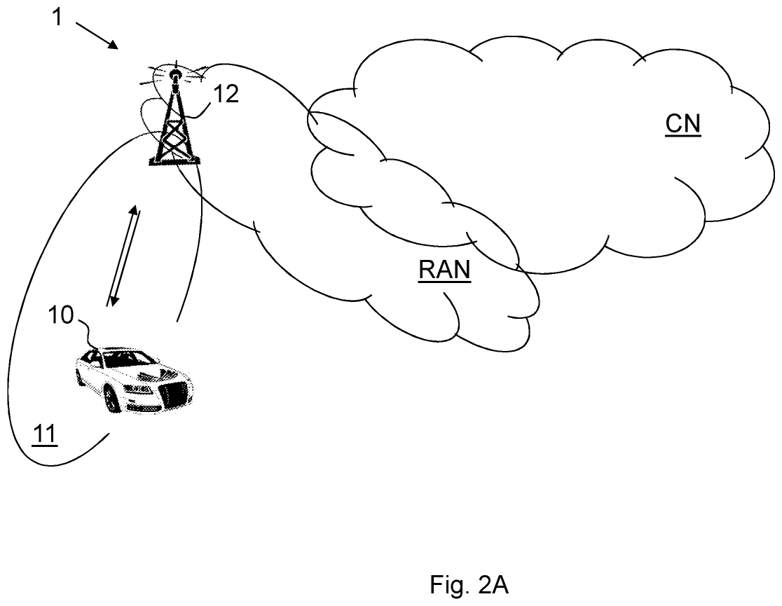

Embodiments herein relate to wireless communication networks in general. FIG. 2A is a schematic overview depicting a wireless communication network 1. The wireless communication network 1 comprises one or more RANs and one or more CNs. The wireless communication network 1 may use one or a number of different technologies, such as New Radio (NR), Wi-Fi, Long Term Evolution (LTE), LTE-Advanced, 5G, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication networks such as e.g. WCDMA and LTE.

In the wireless communication network 1, a wireless device 10, such as a mobile station, a non-access point (non-AP) STA, a STA, a user equipment and/or a wireless terminals, may communicate via one or more Access Networks (AN), e.g. a RAN, to one or more CNs. It should be understood by the skilled in the art that “wireless device” is a non-limiting term which means any terminal, wireless communications terminal, user equipment, Machine Type Communication (MTC) device, Device to Device (D2D) terminal, or node e.g. smart phone, laptop, mobile phone, sensor, relay, mobile tablets or even a small base station communicating within a service area. Embodiments herein generally relate to the resource management of wireless communication networks with the participation of device-to-device capable UEs, such as Vehicle to Vehicle (V2V) authorized UEs or ProSe authorized UEs.

The wireless communication network 1 comprises a radio network node 12 providing radio coverage over a geographical area referred to as service area 11 or cell, which may be provided by one or more beams or a beam group where the group of beams is covering the service area of a first radio access technology (RAT), such as NR, 5G, LTE, Wi-Fi or similar. A radio network node, such as the radio network node 12, may also serve multiple cells. The radio network node 12 may be a transmission and reception point e.g. a radio-access network node such as a Wireless Local Area Network (WLAN) access point or Access Point Station (AP STA), an access controller, a base station e.g. a radio base station such as a NodeB, an evolved Node B (eNB, eNode B), a gNodeB, a base transceiver station, a radio remote unit, an Access Point Base Station, a base station router, a transmission arrangement of a radio base station, a stand-alone access point or any other network unit capable of communicating with a wireless device within the service area served by the radio network node depending e.g. on the radio access technology and terminology used. The radio network node 12 communicates with the wireless device 10 with Downlink (DL) transmissions to the wireless device 10 and Uplink (UL) transmissions from the wireless device 10.

As stated above the radio network node 12 may determine values of transmission parameters that are overlapping and configure the wireless device with these overlapping values. However, it is not always beneficial to configure different sets of values of transmission parameters so that an overlap is ensured. If such overlap is not ensured by the network configuration, it is ambiguous which set of transmission resources the wireless device should select. Additionally, even in case overlapping is ensured for some values of transmission parameters, e.g. for the number of PRBs to be used, it might not be ensured for other value of transmission parameters, e.g. for the MCS to be used. Therefore in such case, it is ambiguous which set of values of transmission parameters from which the wireless device should select such other transmission parameters, e.g. the MCS.

Embodiments herein enable the wireless device 10 to select the proper set of values of transmission parameters among multiple sets of values of transmission parameters which may be configured by the radio network node 12 (or preconfigured) depending on the different conditions of the wireless device 10. Embodiments herein define criteria the wireless device 10 follows when the wireless device 10 selects a set of values of transmission parameters among possible multiple sets of values of transmission parameters the radio network node may configure. The herein disclosed methods ensure or at least enable that system performances, e.g. in terms of transmission reliability, transmission rate, network load, are taken into account when selecting values of transmission parameters for the wireless device 10.

In embodiments herein it is considered for simplicity that the set of values of transmission parameters may e.g. be speed-dependent being a wireless device related condition and/or congestion-dependent being a network related condition. However, the methods disclosed hereinmay easily be extended to other wireless device-related conditions, e.g. location, direction, battery, category of the wireless device e.g. if it is a prioritized/privileged wireless device, service to be transmitted by the wireless device, etc. Similarly, it is assumed that the radio network node 12 provides values for transmission parameters such as PRB ranges, MCS ranges, number of HARQ retransmissions, Transmission (TX) power ranges. However, the methods disclosed hereinafter may be extended to values of other transmission parameters, e.g. number of Multiple Input Multiple Output (MIMO) layers to use, synchronization references to use, number of transmit antennas to use, etc. In addition, a pre-configuration may be use for some/all of the parameters.

In some embodiments, the wireless device 10 may obtain the multiple sets of values of transmission parameters by receiving the multiple sets of values of transmission parameters from the radio network node 12 in broadcast signalling or in dedicated signaling, e.g., Radio Resource Control (RRC) signalling. Additionally or alternatively, the wireless device 10 may be preconfigured, e.g. by an application server, or in the Universal Integrated Circuit Card (UICC) and/or in the Mobile Equipment (ME) i.e. the wireless device, with the multiple sets of values of transmission parameters. Such multiple sets of values of transmission parameters may comprise values based on e.g. position of the wireless device 10, speed/acceleration of the wireless device 10, congestion status of the network/cell, battery of the wireless device 10, category of the wireless device, e.g., if it is a prioritized or privileged wireless device. A prioritized or privileged wireless device means that the wireless device e.g. has a subscription stating that the wireless device is prioritized or has certain quality of service requirements.

The method actions performed by the wireless device 10 for handling communication in the wireless communication network 1 according to embodiments herein will now be described with reference to a flowchart depicted in FIG. 2B. The actions do not have to be taken in the order stated below, but may be taken in any suitable order. Actions performed in some embodiments are marked with dashed boxes.

Action 201. The wireless device 10 may obtain multiple sets of values of transmission parameters.

Action 202. The wireless device 10 determines sets of values of transmission parameters based on two or more conditions, wherein the transmission parameters are related to wireless devices. The two or more conditions may comprise a congestion condition dependent on congestion of traffic being an example of a network related condition, a movement condition dependent on speed and/or direction of the wireless device, a location condition dependent on location of the wireless device, and/or a capacity condition dependent on capacity of the wireless device. The sets of values may be determined by being selected from the obtained multiple sets of values.

Action 203. The wireless device 10 further determines whether there is one or more overlapping values of the sets of values.

Action 2041. When determined that there is one or more overlapping values, the wireless device 10 selects a value of the one or more overlapping values.

Action 2042. When determined that there is no overlapping values, the wireless device 10 selects a value from the sets of values of transmission parameters based on a criteria. The criteria may be related to a priority of the set of values of transmission parameters in relation to another set.

Action 205. The wireless device 10 may then use the selected value during communication. The selected value may indicate a transmission or a non-transmission e.g. a zero value.

The method actions performed by the radio network node 12 for handling radio resources of the wireless communication network 1 according to embodiments herein will now be described with reference to a flowchart depicted in FIG. 2C. The actions do not have to be taken in the order stated below, but may be taken in any suitable order. Actions performed in some embodiments are marked with dashed boxes.

Action 211. The radio network node 12 configures the wireless device 10 with multiple sets of values of transmission parameters, wherein the transmission parameters are related to conditions being network related conditions such as the congestion condition and/or wireless device related conditions such as the speed condition.

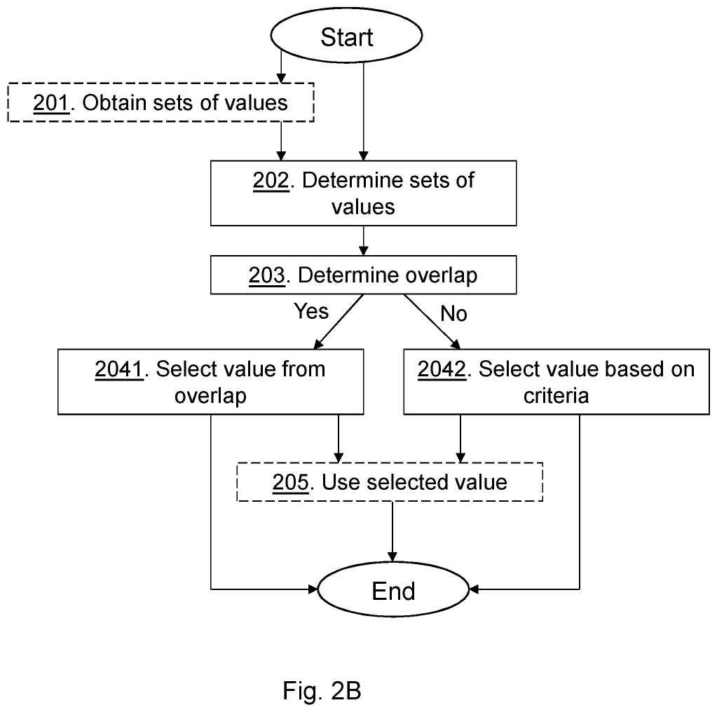

The following is an example of embodiments herein performed by the wireless device 10 as shown in FIG. 3:

Action 301. The wireless device 10 determines a candidate set of values for one or more transmission parameters that the wireless device 10 may use depending on its condition, e.g. position, direction, speed/acceleration, congestion status, battery, category, service to be transmitted. This is an example of action 202 in FIG. 2B. Assuming for simplicity that the radio network node 12 only configures two sets of values of transmission parameters, e.g. one speed-dependent and one congestion-dependent, say such candidate transmission parameters are denoted as:
a. Speed-ParametersB (PRB-RangeB, MCS-RangeB, RetransmissionB, TX-PowerB, etc.)
b. Cong-ParametersA (PRB-RangeA, MCS-RangeA, RetransmissionA, TX-PowerA, etc.)

Action 302. For each transmission parameter, i.e. PRB range, MCS range, HARQ range, TX power etc., the wireless device 10 determines if there is any overlap, i.e., are there any common values, across multiple set of values, e.g. across PRB-RangeA in Cong-ParametersA and PRB-RangeB in Speed-ParametersB; across MCS-RangeA in Cong-ParametersA and MCS-RangeB in Speed-ParametersB; etc. This is an example of action 203 in FIG. 2B.

Action 303. If there is an overlap the wireless device 10 selects a respective value for the transmission parameters that belongs to this overlap. That is, a value that belongs to both sets of values.

Action 304. If there is no overlap between the sets of values, i.e. PRB range, MCS range, HARQ range, TX power etc., the wireless device 10 follows the selection criteria disclosed below. In some embodiments, action 304 is used only for certain transmission parameters. For example: for PRB range there is an overlap between PRB-RangeA in Cong-ParametersA and PRB-RangeB in Speed-ParametersB and consequently, the wireless device 10 chooses a value in the overlap between both ranges, see action 2041 in FIG. 2B; for MCS range there is no overlap between MCS-RangeA in Cong-ParametersA and MCS-RangeB in Speed-ParametersB and consequently, the wireless device 10 uses action 304 to choose an MCS value, which is an example of the action 2042 in FIG. 2B.

For the action 304, one of the following selection criteria may be followed by the wireless device 10:
Each set of values of transmission parameters is given a priority. For example, congestion-aware values are given highest priority. When no overlapping is detected the wireless device 10 may select the transmission parameter from the set of the highest priority. The (pre)-configuration of such priority may depend on e.g. location of the wireless device 10, or UE measurements. For example, in a city center the use of congestion-aware transmission parameters is prioritized over speed-aware transmission parameters. In a highway, the opposite behavior is used;
A priority is given to each set of values of transmission parameter, e.g. if the CBR >70% priority 1 is given so that the wireless device 10 should always prioritize selection of a value of the transmission parameters from the congestion-aware set of values of transmission parameters when CBR>70%, while for CBR <20% the priority is lower, thus each set of values may have different priorities under different conditions.
   CBR >70%: Prio 1
   Speed >100 kmph: Prio 2
   CBR 20%-70%: Prio 3
   Speed 60 kmph-100 kmph: Prio 4
   CBR 20%-70%: Prio 5
   Speed 0 kmph-60 kmph: Prio 6
The radio network node 12 may ensure that the priority associated to a single threshold is unique across the multiple thresholds for the different sets. Alternatively, if more than one set is given the same priority a second criterion may be used, e.g., from this list;
The wireless device 10 may randomly select one set of values of the transmission parameter. The random function can be such that each set may be chosen with equal probability or following a certain (pre)configured probability which is associated to the set of transmission parameter (therefore depending on the priority of the set as in criteria 1) or associated to different thresholds across the multiple sets (therefore depending on the priority of the different thresholds across different sets as in criteria 2);
The wireless device 10 may select the set of values of transmission parameters that are most restrictive. For example, if PRB-RangeA in Cong-ParametersA indicates a range [10-20] PRBs and PRB-RangeB in Speed-ParametersB indicates [50-100] PRBs, the wireless device 10 may select a values of the set with the less interval, also referred to as range or number of PRBs, e.g. PRB-RangeA in Cong-ParametersA since maximum 20 PRBs will be used.
   Alternative criteria is that the wireless device 10 selects the set of values of transmission parameters that are more aggressive, i.e. PRB-RangeB in Speed-ParametersB
   In case the two sets are partly overlapping, e.g. PRB-RangeA in Cong-ParametersA [10, 20] and PRB-RangeB in Speed-ParametersB indicates [5-25] PRBs, the lowest upper bound is considered when selecting the set, i.e. the lowest upper bound is 20, therefore PRB-RangeA in Cong-ParametersA is used. Alternatively, the lowest lower bound may be considered, i.e. the lowest lower bound is 5, therefore PRB-RangeB in Speed-ParametersB is used. Alternatively, first it is considered the lowest upper bound and if it is the same for multiple sets, the lowest lower bound is considered.
The wireless device 10 may select the transmission parameter value from union of the transmission parameters across multiple sets. In the example in criteria 4, the wireless device 10 may select the number of PRBs to be used from the set union of the sets [10-20] and [50-100];
The wireless device 10 may select the value of the transmission parameter from a (pre)-configured default (or backup) set of transmission parameter values. Such (pre)-configured default (or backup) set of transmission parameter values may be used when there is no overlap between one or more transmission parameters across the different sets;
The wireless device 10 may alternate the usage of the different set of values of transmission parameters. E.g. after N subframes or P transmission or T seconds, the wireless device 10 selects the value of one or more transmission parameters from a different set of values of transmission parameters;
In case there is overlap of values across multiple sets only for some transmission parameters (i.e. PRB range, MCS range, but not for HARQ range or TX power etc.), the wireless device 10 may select another set of values also for those transmission parameters in which there is an overlap. For example, if the wireless device 10 selects HARQ-RangeA in Cong-ParametersA following one of the criteria above, the wireless device 10 may also select the other transmission parameters PRB-RangeA, MCS range, TX-PowerA in Cong-ParametersA regardless of whether there is an overlapping or not.
   A priority may also be associated to the different transmission parameters, so that if there is no overlap for more than one transmission parameter across multiple sets of transmission parameters, the wireless device 10 may first select (following one of the above criteria) the set of values of transmission parameters for the transmission parameter of highest priority. For example, the network may associate priority 1 to PRB range, priority 2 to MCS range, and so on. The wireless device 10 may first select the set of values of transmission parameters from which to select the PRBs, the values of the other transmission parameters are then selected from the same set.

The wireless device 10 may use the criteria mentioned above regardless of the existence of an overlap between the different sets of parameters values or not.

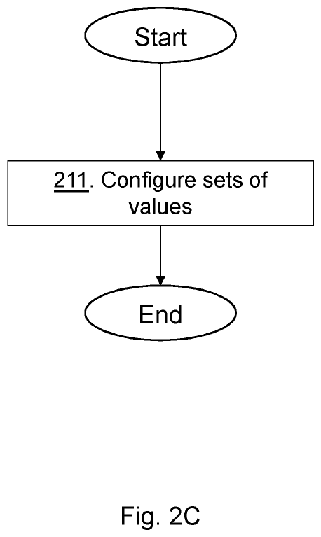

FIG. 4 is a combined flowchart and signaling scheme according to some embodiments herein.

Action 401. The radio network node 12 may determine multiple sets of values of transmission parameters, wherein each set of values is associated to a condition such as congestion in the cell 11, location of the wireless device 10, speed of the wireless device 10.

Action 402. The radio network node 12 may then transmit to (or configure) the wireless device 10 with the multiple sets of transmission parameter values.

Action 403. The wireless device 10 determines a candidate set of values for one or more transmission parameters that the wireless device 10 may use depending on its condition, e.g. position, speed/acceleration, congestion status, battery, category.

Action 404. The wireless device 10 determines whether there is an overlap between two or more sets of transmission parameter values.

Action 405. The wireless device selects a value of a transmission parameter either of overlapping values or a value in a prioritized set of transmission parameter.

Action 406. The wireless device 10 then uses the selected value during transmissions in the wireless communication network.

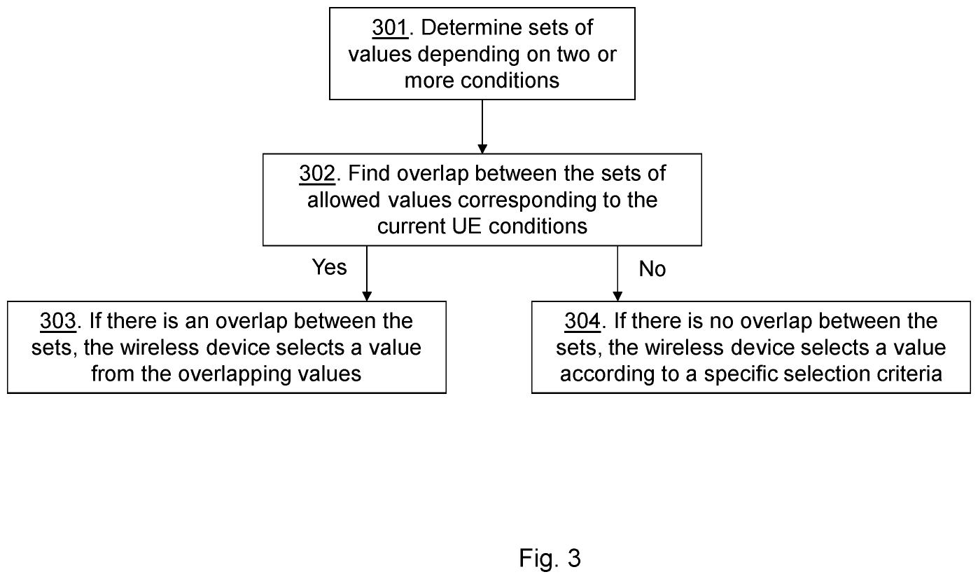

FIG. 5 is a schematic block diagram depicting the wireless device 10 for handling communication in the wireless communication network.

The wireless device 10 may comprise processing circuitry 501, e.g. one or more processors, configured to perform the methods herein.

The wireless device 10 may comprise an obtaining module 502. The wireless device 10, the processing circuitry 501, and/or the obtaining module 502 may be configured, from the radio network node 12 or be pre-configured, to obtain the multiple sets of values of transmission parameters, wherein each set of values of transmission parameters may be associated to a condition such as congestion, location of the wireless device, or a speed of the wireless device.

The wireless device 10 may comprise a determining module 503. The wireless device 10, the processing circuitry 501, and/or the determining module 503 is configured to determine the sets of values of transmission parameters based on the two or more conditions, wherein the transmission parameters are related to wireless devices. The two or more conditions may comprise a congestion condition dependent on congestion of traffic, a movement condition dependent on speed and/or direction of the wireless device, a location condition dependent on location of the wireless device, and/or a capacity condition dependent on capacity of the wireless device. The wireless device 10, the processing circuitry 501, and/or the determining module 503 is further configured to determine whether there is one or more overlapping values of the sets of values. The wireless device 10, the processing circuitry 501, and/or the determining module 503 may be configured to determine the sets of values by selecting from the obtained multiple sets of values. The wireless device 10, the processing circuitry 501, and/or the determining module 503 may e.g. be configured to determine a candidate set of values for one or more transmission parameter that the wireless device 10 may use depending on its condition, e.g. position, speed/acceleration, congestion status, battery, category. The wireless device 10, the processing circuitry 501, and/or the determining module 503 is configured to determine whether there is an overlap between two or more sets of transmission parameter values.

The wireless device 10 may comprise a selecting module 504. The wireless device 10, the processing circuitry 501, and/or the selecting module 504 is configured to, when determined that there is one or more overlapping values, select a value of the one or more overlapping values. The wireless device 10, the processing circuitry 501, and/or the selecting module 504 is configured to, when determined that there is no overlapping values select a value from the sets of values of transmission parameters based on a criteria. The criteria may be related to a priority of the set of values of transmission parameters in relation to one another set. The wireless device 10, the processing circuitry 501, and/or the selecting module 504 may be configured to select a value of a transmission parameter either of overlapping values or a value in a prioritized set of transmission parameter.

The wireless device 10 may comprise a using module 505. The wireless device 10, the processing circuitry 501, and/or the using module 505 may be configured to use the selected value during communication e.g. performing transmissions in the wireless communication network.

The wireless device 10 further comprises a memory 506 comprising one or more memory units. The memory 506 comprises instructions executable by the processing circuitry 501 to perform the methods herein when being executed in the wireless device 10. The memory 506 is arranged to be used to store e.g. information, data such as sets of transmission parameter values, conditions, locations, speed, category, etc.

The methods according to the embodiments described herein for the wireless device 10 are respectively implemented by means of e.g. a computer program product 507 or a computer program, comprising instructions, i.e., software code portions, which, when executed on at least one processor, cause the at least one processor to carry out the actions described herein, as performed by the wireless device 10. The computer program product 507 may be stored on a computer-readable storage medium 508, e.g. a disc, a universal serial bus (USB) stick or similar. The computer-readable storage medium 508, having stored thereon the computer program product 507, may comprise the instructions which, when executed on at least one processor, cause the at least one processor to carry out the actions described herein, as performed by the wireless device 10. In some embodiments, the computer-readable storage medium 508 may be a non-transitory computer-readable storage medium. Thus, the wireless device 10 may comprise the processing circuitry 501 and the memory 506, said memory 506 comprising instructions executable by said processing circuitry 501 whereby said wireless device 10 is operative to perform the methods herein.

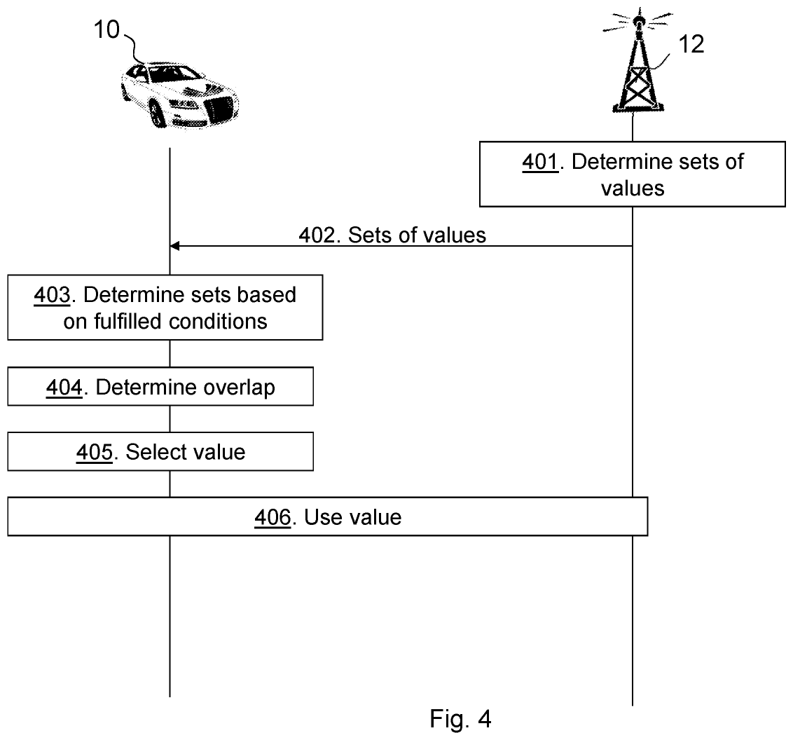

FIG. 6 is a schematic block diagram depicting the radio network node 12 for enabling communication e.g. setting transmission parameter values, for the wireless device 10 in the wireless communication network 1.

The radio network node 12 may comprise processing circuitry 601, e.g. one or more processors, configured to perform the methods herein.

The radio network node 12 may comprise a configuring module 602. The radio network node 12, the processing circuitry 601, and/or the configuring module 602 is configured to configure the wireless device 10 with multiple sets of values of transmission parameters, wherein the transmission parameters are related to network related conditions and/or wireless device related conditions and are for the wireless device to select from, e.g. conditions being either network related conditions or wireless device related conditions or both. The sets may be associated with different wireless device conditions.

The radio network node 12 may comprise a determining module 603. The radio network node 12, the processing circuitry 601, and/or the determining module 603 may be configured to determine the multiple sets of transmission parameter values.

The radio network node 12 further comprises a memory 604 comprising one or more memory units. The memory 604 comprises instructions executable by the processing circuitry 601 to perform the methods herein when being executed in the radio network node 12. The memory 604 is arranged to be used to store e.g. information, data such as configurations, sets, values, etc.

The methods according to the embodiments described herein for the radio network node 12 are respectively implemented by means of e.g. a computer program product 605 or a computer program, comprising instructions, i.e., software code portions, which, when executed on at least one processor, cause the at least one processor to carry out the actions described herein, as performed by the radio network node 12. The computer program product 605 may be stored on a computer-readable storage medium 606, e.g. a disc, a USB stick, or similar. The computer-readable storage medium 606, having stored thereon the computer program product 605, may comprise the instructions which, when executed on at least one processor, cause the at least one processor to carry out the actions described herein, as performed by the radio network node 12. In some embodiments, the computer-readable storage medium may be a non-transitory computer-readable storage medium. Thus, the radio network node 12 may comprise the processing circuitry 601 and the memory 604, said memory 604 comprising instructions executable by said processing circuitry 601 whereby said radio network node 12 is operative to perform the methods herein.

As will be readily understood by those familiar with communications design, means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless terminal or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications receivers will appreciate the cost, performance, and maintenance tradeoffs inherent in these design choices.

It is herein disclosed that the wireless device may obtain multiple sets of transmission parameters, which transmission parameters are wireless device related. The wireless device determines sets of transmission parameter values based on two or more conditions, such as congestion of traffic and speed of the wireless device. The wireless device determines whether there is one or more overlapping values of the sets of transmission parameter values. That being the case, the wireless device selects a value of the one or more overlapping values. That not being the case, the wireless device selects a value from the set of transmission parameter values based on a criteria such as a set of a highest priority.

It is further herein disclosed a method performed by a radio network node for handling resources of a wireless communication network. The radio network node configures the wireless device with multiple sets of transmission parameters, wherein the transmission parameters are related to conditions either network related conditions or wireless device related conditions.

It is furthermore provided herein a computer program comprising instructions, which, when executed on at least one processor, cause the at least one processor to carry out any of the methods above, as performed by the wireless device or the radio network node. It is additionally provided herein a computer-readable storage medium, having stored thereon a computer program comprising instructions which, when executed on at least one processor, cause the at least one processor to carry out the method according to any of the methods above, as performed by the wireless device or the radio network node.

A radio network node and a wireless device are also herein provided to perform the methods herein.

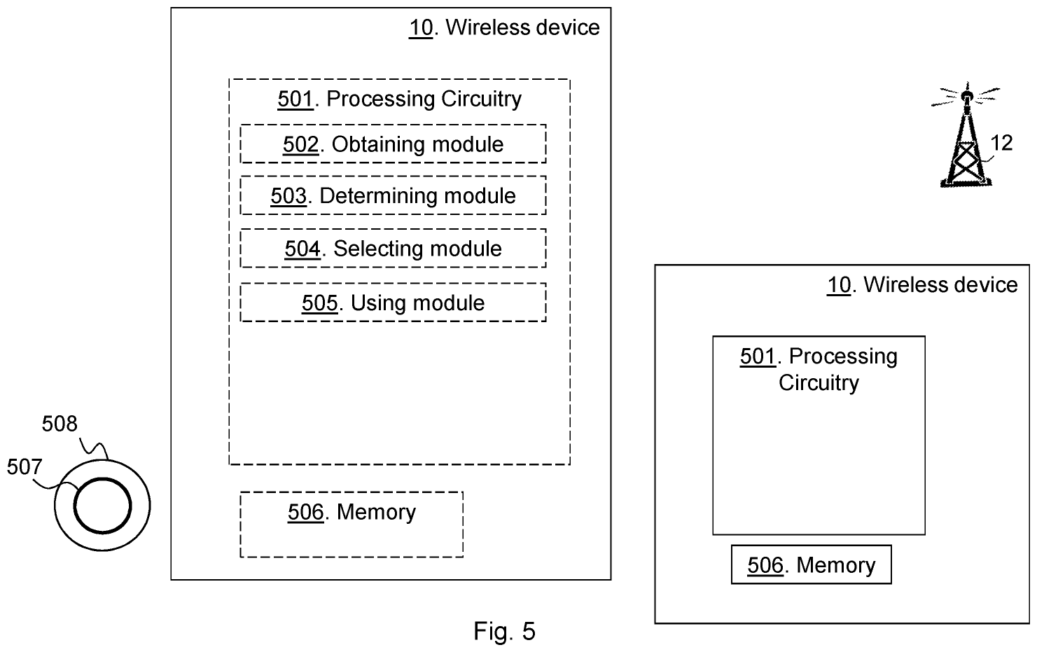

With reference to FIG. 7, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the wireless device 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 7 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

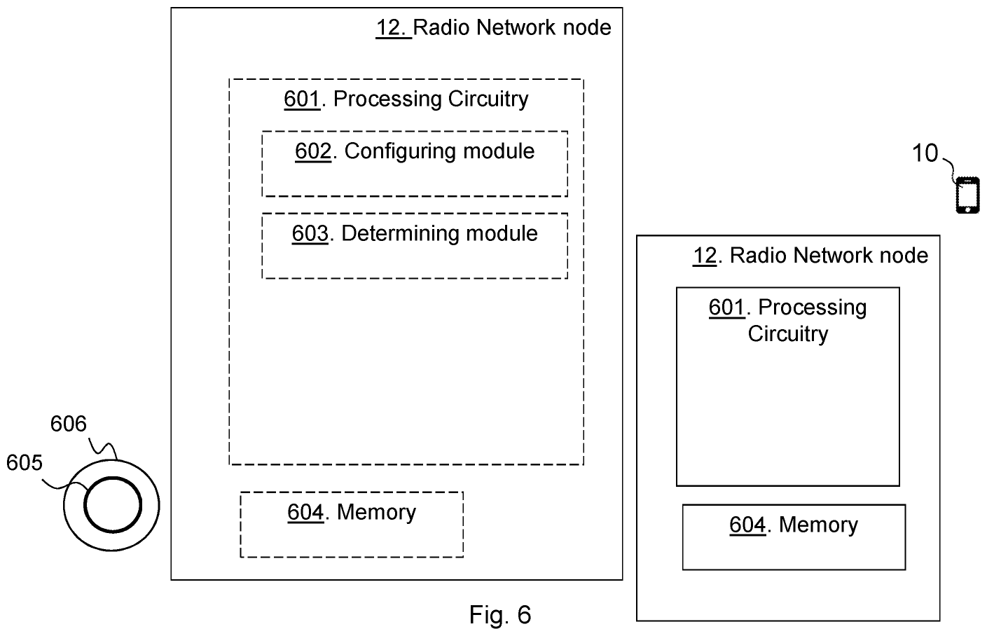

Example implementations, in accordance with an embodiment, of the UE, base station and host computer discussed in the preceding paragraphs will now be described with reference to FIG. 8. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 8) served by the base station 3320. The communication interface 3326 may be configured to facilitate a connection 3360 to the host computer 3310. The connection 3360 may be direct or it may pass through a core network (not shown in FIG. 8) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 8 may be identical to the host computer 3230, one of the base stations 3212a, 3212b, 3212c and one of the UEs 3291, 3292 of FIG. 7, respectively. This is to say, the inner workings of these entities may be as shown in FIG. 8 and independently, the surrounding network topology may be that of FIG. 7.

In FIG. 8, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the latency by letting the wireless device select values of transmission parameters that are overlapping of the sets and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

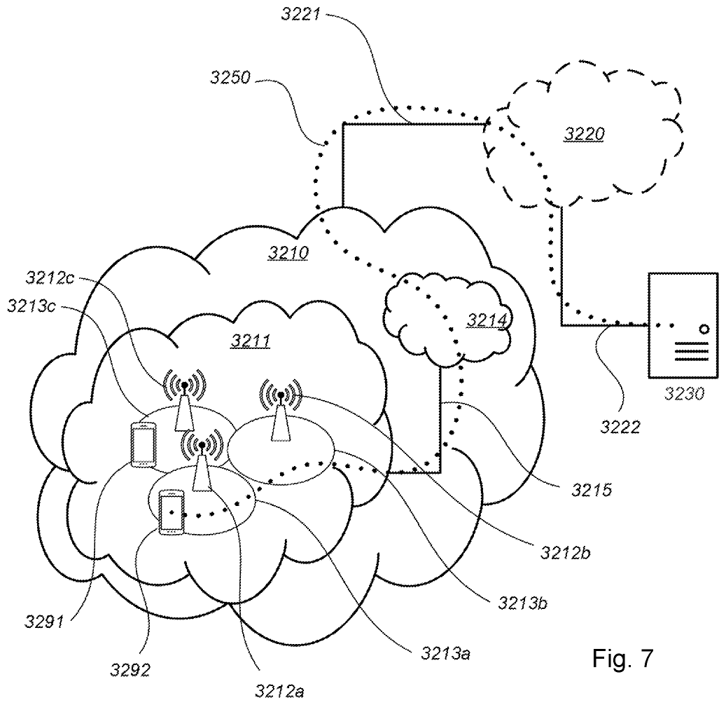

FIG. 9 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 9 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

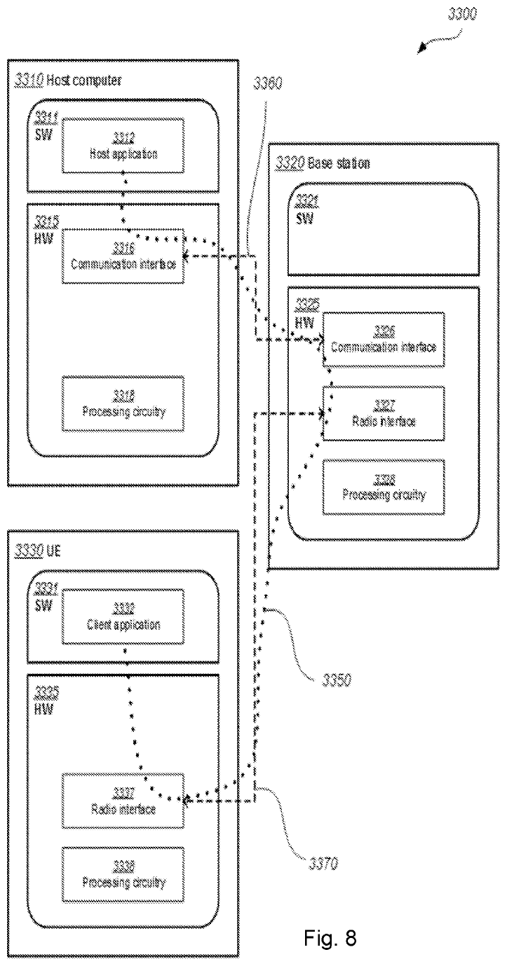

FIG. 10 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 10 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

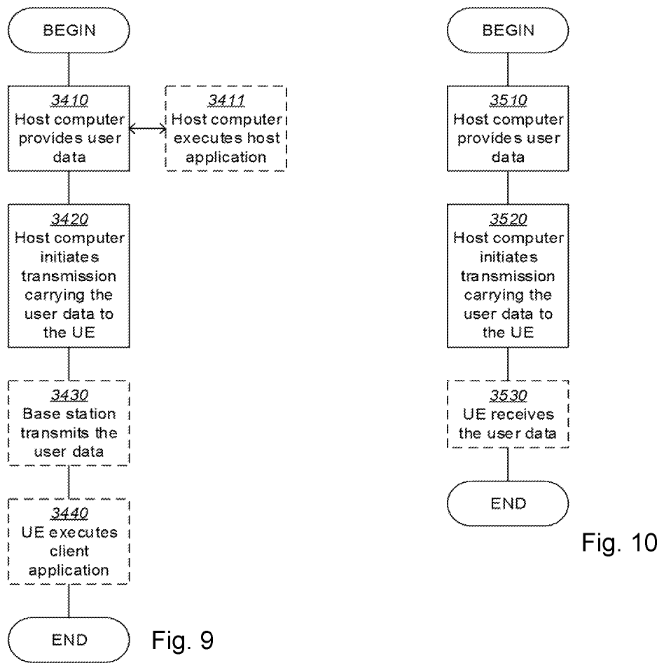

FIG. 11 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 11 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

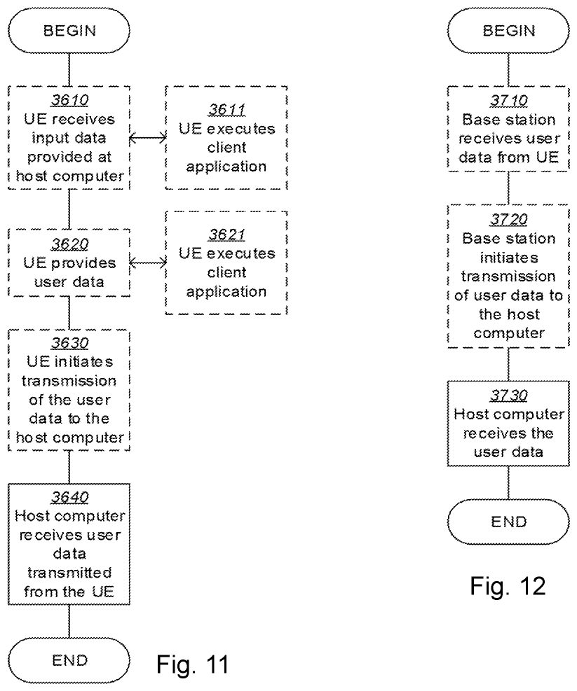

FIG. 12 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 12 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1.-16. (canceled)

17. A method performed by a wireless device for handling communication in a wireless communication network, the method comprising
determining two or more sets of values of transmission parameters, wherein:
the two or more sets correspond to respective two or more conditions, and
the transmission parameters are related to wireless devices;
determining whether there are one or more overlapping values in the two or more sets; and
based on determining that there are one or more overlapping values, selecting a value of the one or more overlapping values; and
based on determining that there are no overlapping values, selecting a value from the two or more sets of values of transmission parameters based on a criteria.

18. The method according to claim 17, wherein the two or more conditions include any of the following:
a congestion condition dependent on congestion of traffic in the wireless communication network,
a movement condition dependent on speed and/or direction of the wireless device,
a location condition dependent on location of the wireless device, and
a capacity condition dependent on capacity of the wireless device.

19. The method according to claim 17, wherein the criteria is related to at least one of the following:
relative priorities of the two or more sets of values,
relative priorities of the two or more conditions, and
relative priorities of particular values within the two or more sets of values.

20. The method according to claim 17, further comprising obtaining multiple sets of values of transmission parameters from a network node in the wireless communication network, and wherein determining the two or more sets of values comprises selecting the two or more sets from the obtained multiple sets of values.

21. The method according to claim 17, further comprising using the selected value during communication in the wireless communication network.

22. A method performed by a radio network node for handling resources of a wireless communication network; the method comprising:
configuring a wireless device with multiple sets of values of transmission parameters, wherein the multiple sets include two or more sets corresponding to respective two or more conditions related to the wireless device or the wireless communication network; and
communicating with the wireless device based on a particular transmission parameter value in the two or more sets, wherein the particular transmission parameter value depends on whether there are any overlapping transmission parameter values in the two or more sets.

23. The method of claim 22, wherein the two or more conditions include any of the following:
a congestion condition dependent on congestion of traffic in the wireless communication network,
a movement condition dependent on speed and/or direction of the wireless device,
a location condition dependent on location of the wireless device, and
a capacity condition dependent on capacity of the wireless device.

24. A wireless device for handling communication in a wireless communication network, wherein the wireless device comprises:
processing circuitry; and
a memory storing instructions executable by the processing circuitry, whereby the wireless device is configured to:
determine two or more sets of values of transmission parameters, wherein:
the two or more sets correspond to respective two or more conditions, and
the transmission parameters are related to wireless devices;
determine whether there are one or more overlapping values in the two or more sets; and
based on determining that there are one or more overlapping values, select a value of the one or more overlapping values; and
based on determining that there are no overlapping values, select a value from the two or more sets of values of transmission parameters based on a criteria.

25. The wireless device according to claim 24, wherein the two or more conditions include any of the following:
a congestion condition dependent on congestion of traffic in the wireless communication network,
a movement condition dependent on speed and/or direction of the wireless device,
a location condition dependent on location of the wireless device, and
a capacity condition dependent on capacity of the wireless device.

26. The wireless device according to claim 24, wherein the criteria is related to at least one of the following:
relative priorities of the two or more sets of values,
relative priorities of the two or more conditions, and
relative priorities of particular values within the two or more sets of values.

27. The wireless device according to claim 24, wherein:
execution of the instructions further configures the wireless device to obtain multiple sets of values of transmission parameters from a network node in the wireless communication network; and
the wireless device is configured to determine the two or more sets of values by selecting the two or more sets from the obtained multiple sets of values.

28. The wireless device according to claim 24, wherein execution of the instructions further configures the wireless device to use the selected value during communication in the wireless communication network.

29. A radio network node for handling resources of a wireless communication network, wherein the radio network node comprises:
processing circuitry; and
a memory storing instructions executable by the processing circuitry, whereby the radio network node is configured to:
configure a wireless device with multiple sets of values of transmission parameters, wherein the multiple sets include two or more sets corresponding to respective two or more conditions related to the wireless device or the wireless communication network; and
communicate with the wireless device based on a particular transmission parameter value in the two or more sets, wherein the particular transmission parameter value depends on whether there are any overlapping transmission parameter values in the two or more sets.

30. The radio network node according to claim 29, wherein the two or more conditions include any of the following:
a congestion condition dependent on congestion of traffic in the wireless communication network,
a movement condition dependent on speed and/or direction of the wireless device,
a location condition dependent on location of the wireless device, and
a capacity condition dependent on capacity of the wireless device.

31. A non-transitory, computer-readable medium storing program instructions that, when executed by processing circuitry of a wireless device, configure the wireless device to perform operations corresponding to the method of claim 17.

32. A non-transitory, computer-readable medium storing program instructions that, when executed by processing circuitry of a radio network node, configure the radio network node to perform operations corresponding to the method of claim 22.
